(19) United States
(12) Patent Application Publication
(10) Pub. No.: US 2019/0208749 A1
(43) Pub. Date: Jul. 11, 2019

(54) Incubator

(71) Applicant: Benjamin T. Clark, JR., South Bend, IN (US)

(72) Inventor: Benjamin T. Clark, JR., South Bend, IN (US)

(21) Appl. No.: 15/864,089

(22) Filed: Jan. 8, 2018

(51) Int. Cl. A01K 41/02; A01K 41/04; A01K 41/06

(52) U.S. Cl. CPC A01K 41/023; A01K 41/06; A01K 41/04

(57) ABSTRACT

A tabletop style incubator that includes an integrated water reservoir in the form of channels formed in the floor of the base tray and fill ports that allow water to be added to the incubator without removing the top assembly from the bottom assembly. The incubator incorporates conventional incubator features, such as, electronic controls for heat, humidity and time, and an automated egg turner. The base tray of the bottom assembly base tray includes a pair of thermoplastic shells that are bonded together around an inner expanded polystyrene core. The base tray is also configured with a pair of recessed channels that serve as two separate water troughs or reservoirs. A fill port extends through opposed sidewalls of the base tray into each channel and is enclosed by a removable plug.

This invention relates to an egg incubator, and in particular, a tabletop style egg incubator having an integrated water reservoir and fill port.

### BACKGROUND AND SUMMARY OF THE INVENTION

Egg incubators are designed to keep eggs at the correct temperature and humidity during the incubation period. Egg incubators are available in a number of styles and capacities. Tabletop style incubators are designed to incubate a few dozen egg at a time. Typically, conventional tabletop incubators use a two piece design with a base and removable top or cover and support conventional incubator features, such as electronically controlled temperature, humidity, automated egg rotation and displayed incubation time.

Heretofore, conventional tabletop incubators use bases that are basically insulated trays typically constructed or formed of expanded polystyrene. Expanded polystyrene, commonly known as “styrofoam”, is an excellent insulator, but also soft and easily damaged. Moreover, expanded polystyrene is sufficiently porous as to be a host for bacteria and contaminants. In addition, tabletop incubators have used pads, sponges, or small removable cups placed within the incubator interior as water reservoirs. The water in these cups must be periodically replenished, which means removing the cover from the base to access the cups. Removing the cover from the base to replenish the water reservoir disrupts the controlled environment within the incubator and causes significant swings in internal temperature and humidity.

The tabletop style incubator of this invention provides an integrated water reservoir in the form channels formed in the floor of the base tray and fill ports that allow water to be added to the incubator without removing the top assembly from bottom assembly. The incubator incorporates conventional incubator features, such as, electronic controls for heat, humidity and time, and an automated egg turners.

The base tray of the bottom assembly includes a pair of thermoplastic shells that are bonded together around an inner expanded polystyrene core. The thermoplastic shells protect the easily damaged insulating core guard against damages and can be easily cleaned. Enclosing the insulating core within the plastic shells also prevents bacteria and contaminants from migrating into the expanded polystyrene core. The base tray is also configured with a pair of recessed channels that serve as two separate water troughs or reservoirs that hold the water used to maintain the humidity within the incubator. A fill port extends through opposed sidewalls of the base tray into each channel and is enclosed by a removable plug. The fill ports allow water to be deposited directly into each channel without removing the top assembly from the bottom assembly and disrupting the controlled environment of the incubator.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an embodiment of the incubator of this invention;

FIG. 2 is a perspective view of the top assembly of the incubator of FIG. 1;

FIG. 3 is a perspective view of the bottom assembly of the incubator of FIG. 1;

FIG. 4 is a perspective view of the bottom assembly of the incubator of FIG. 1 showing the egg turner removed;

FIG. 5 is a perspective view of the bottom assembly of the incubator of FIG. 1 showing the base tray without the egg turner and screen;

FIG. 6 is another top perspective view of the base tray of the incubator of FIG. 1;

FIG. 7 is a bottom perspective view of the base tray of the incubator of FIG. 1;

FIG. 8 is a side view of the base tray of the incubator of FIG. 1;

FIG. 9 is an end view of the base tray of the incubator of FIG. 1;

FIG. 10 is a top view of the base tray of the incubator of FIG. 1;

FIG. 11 is a bottom view of the base tray of the incubator of FIG. 1; and

FIG. 12 is another top perspective view of the base tray of the incubator of FIG. 1.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

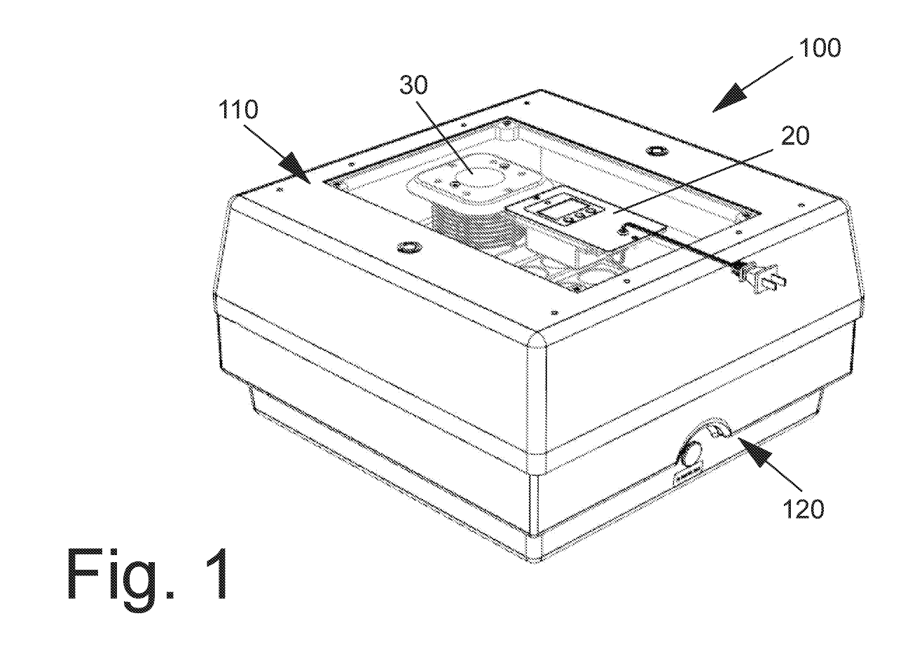

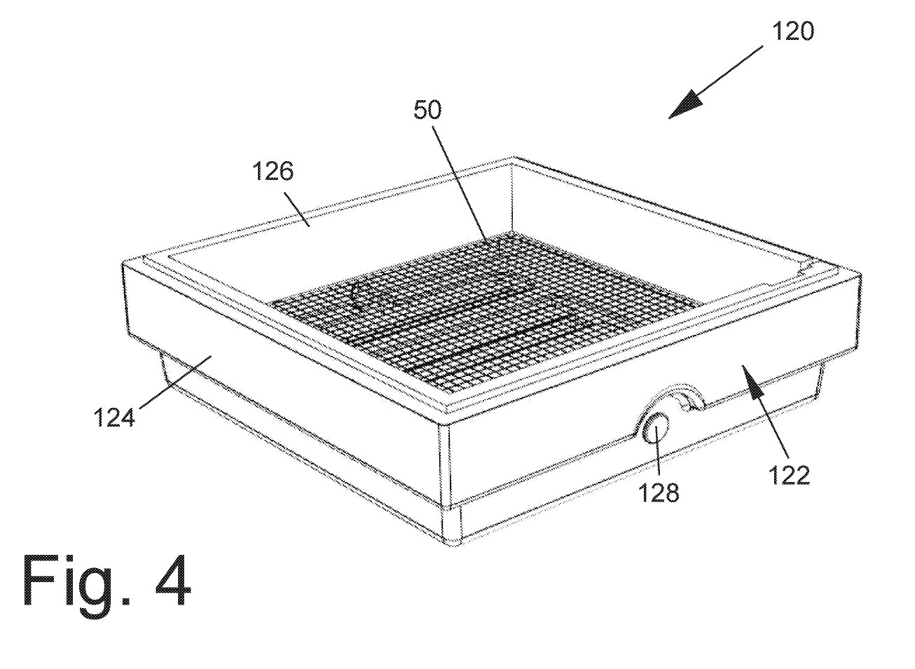

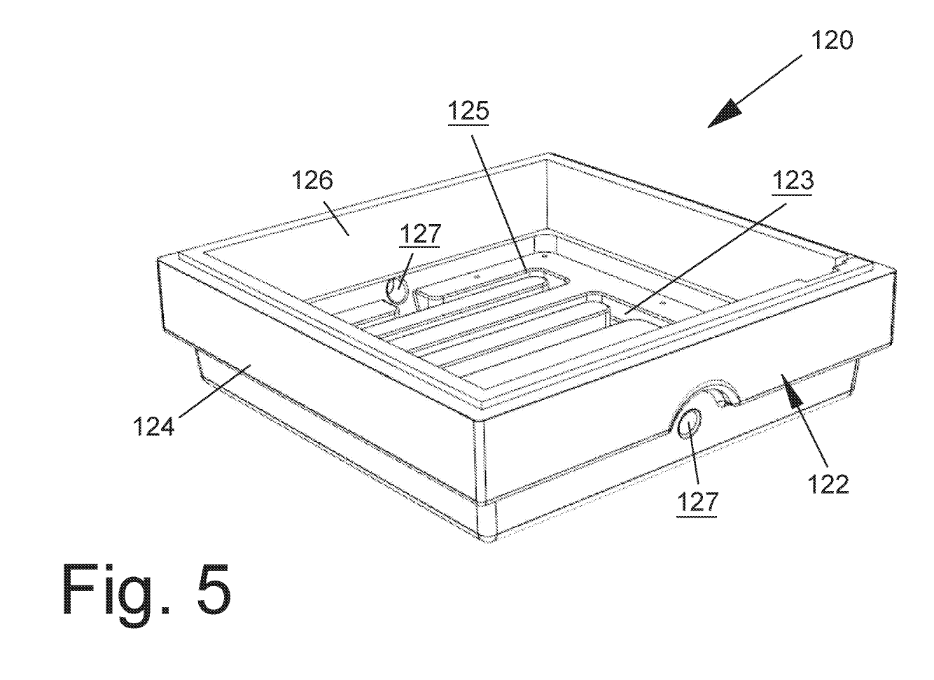

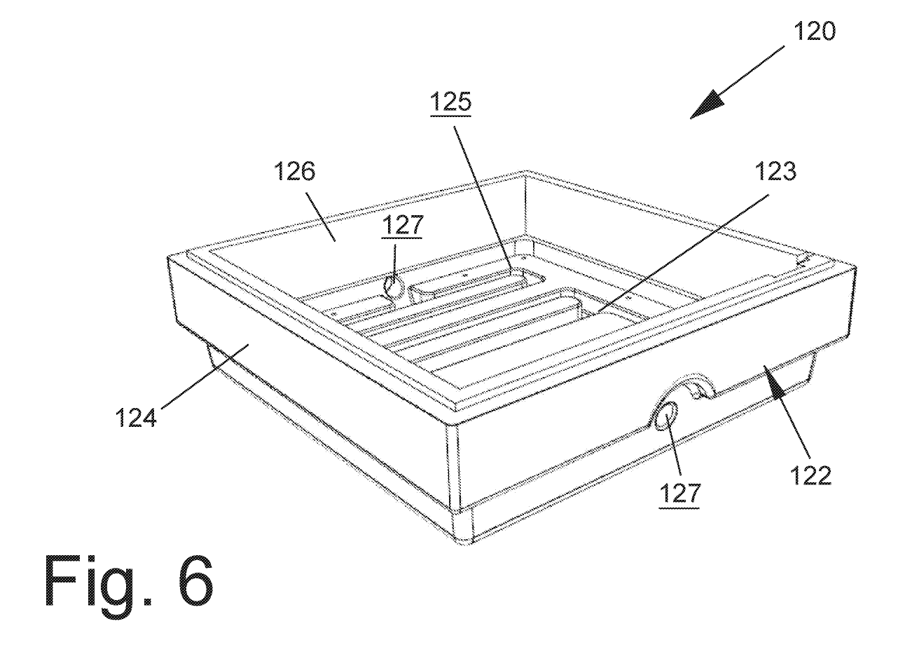

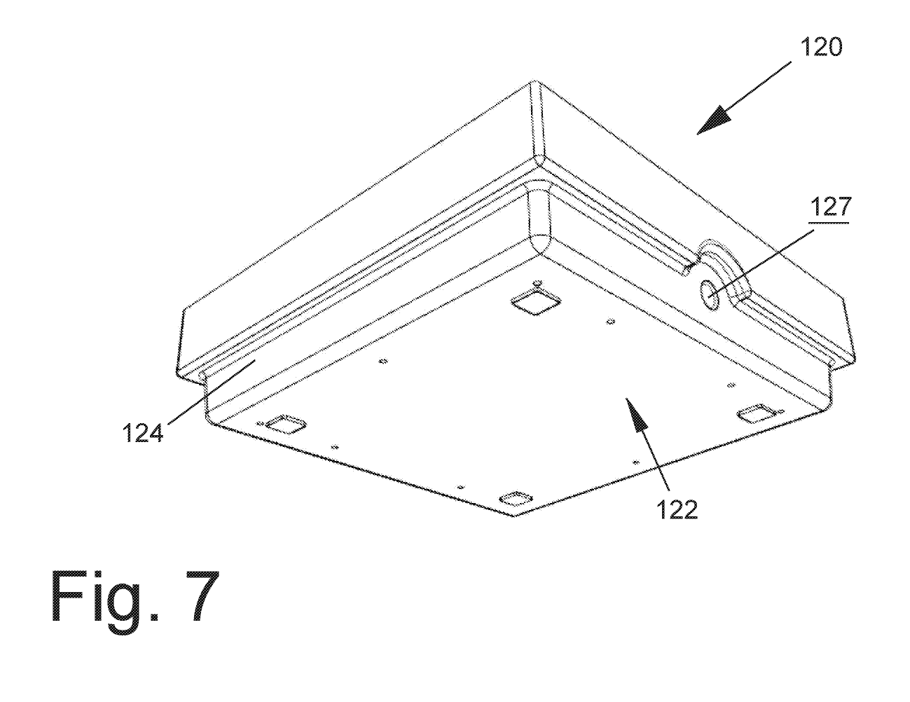

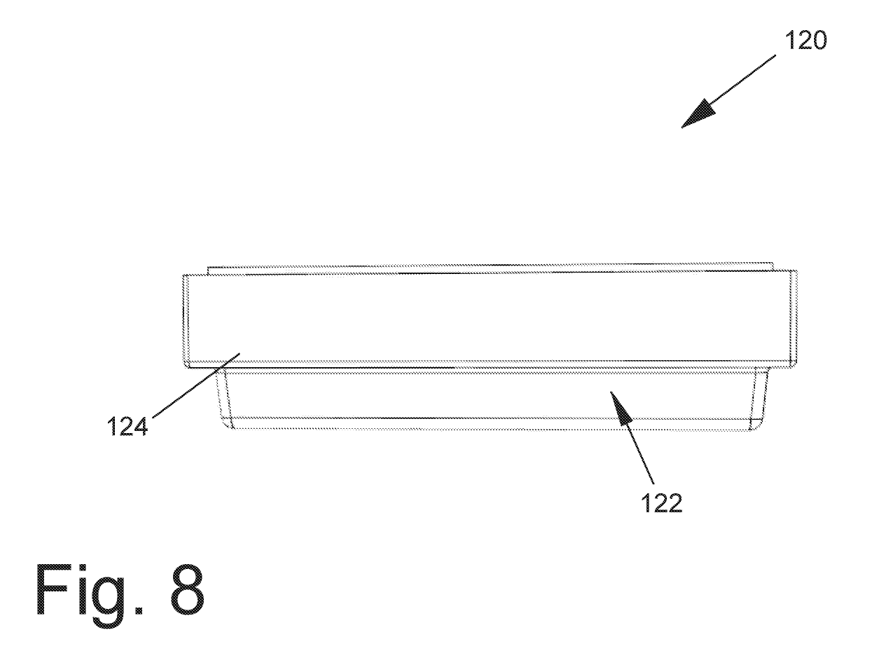

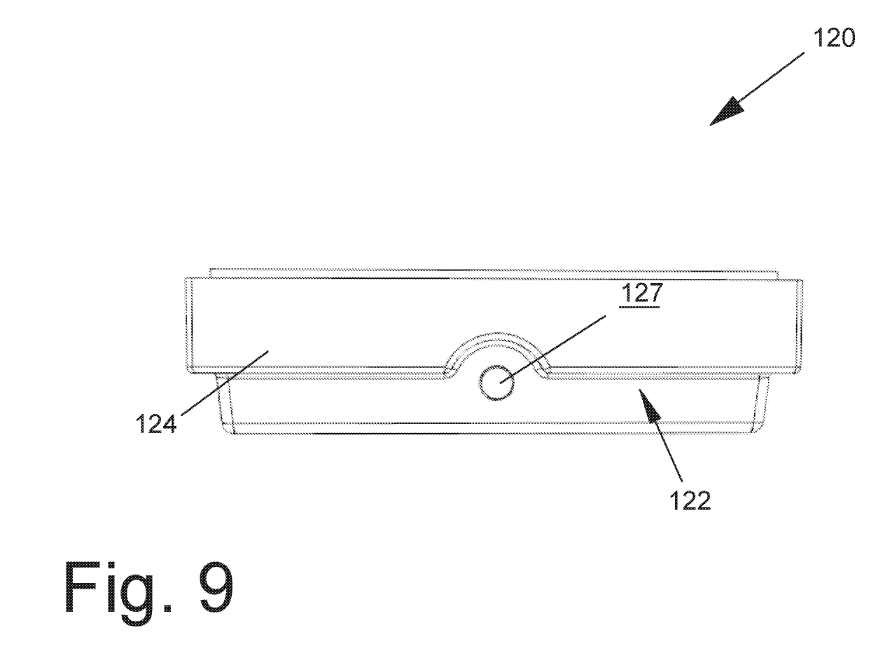

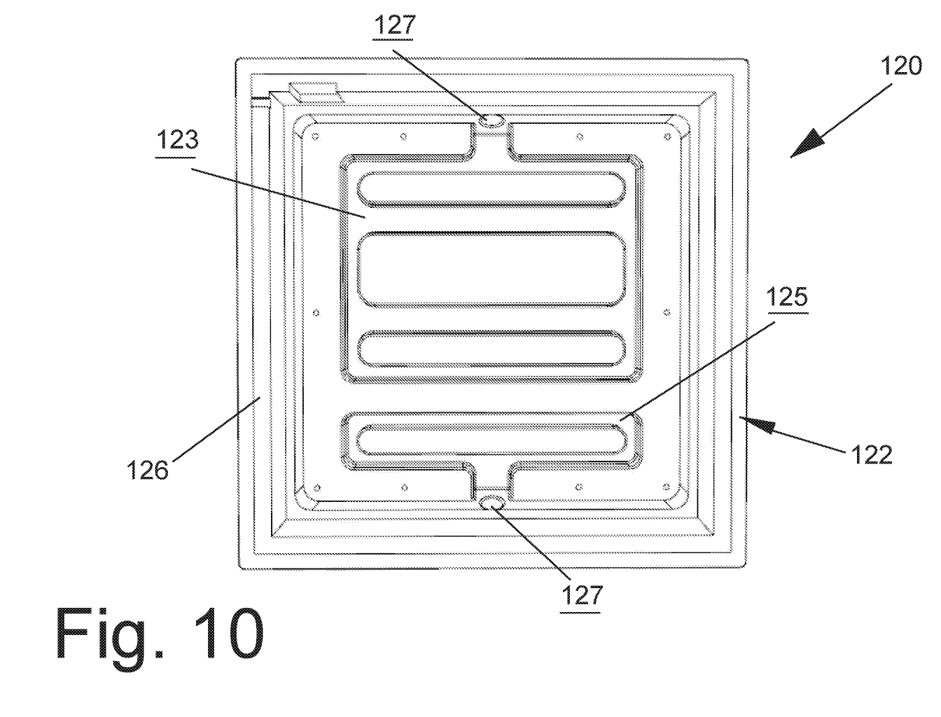

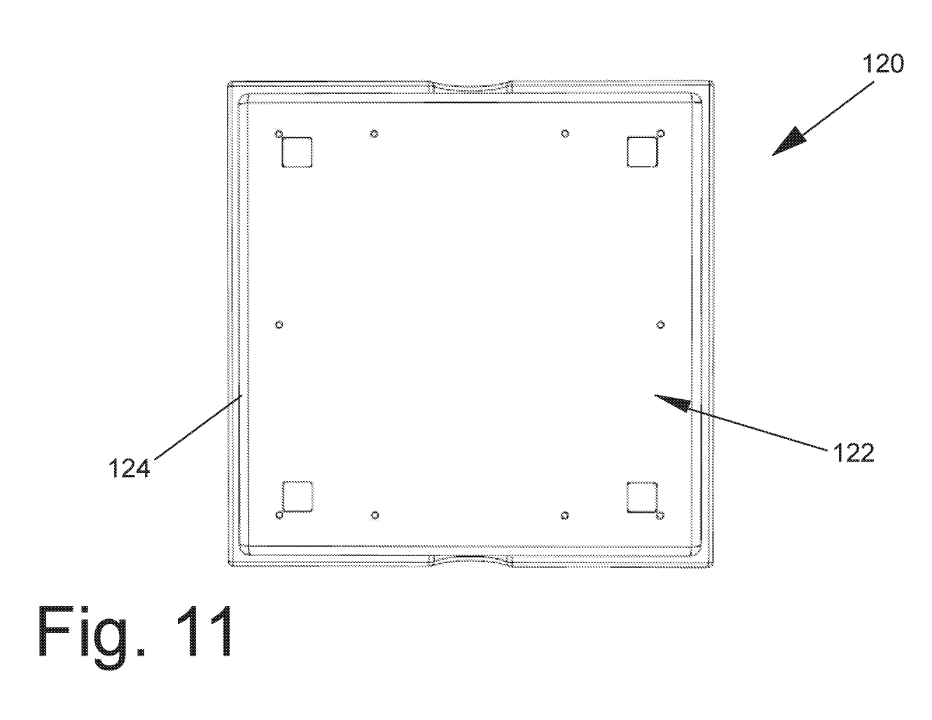

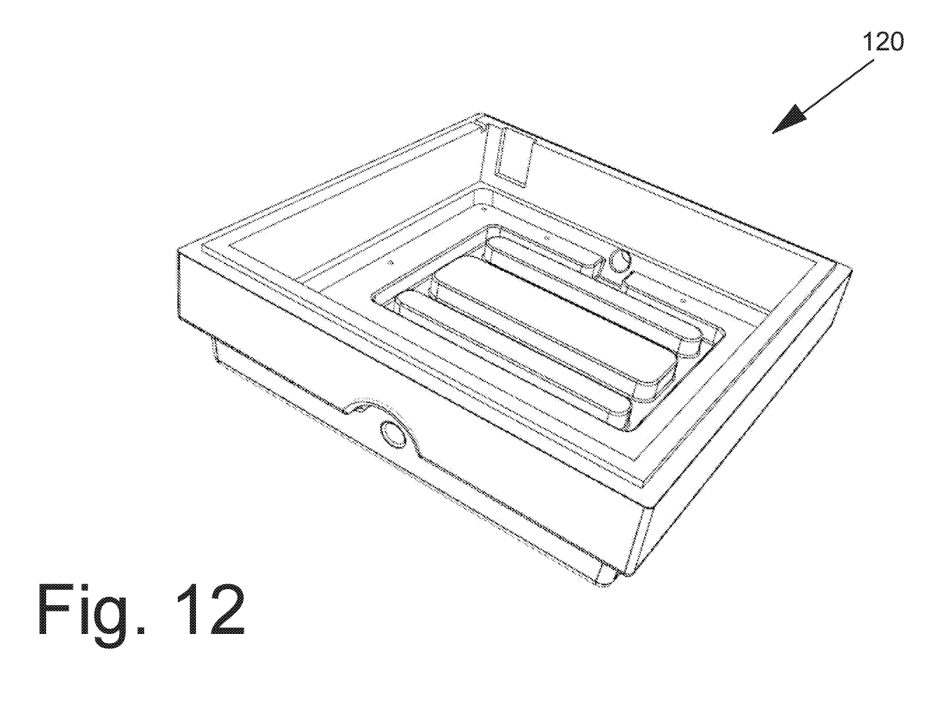

Referring now to the drawings, FIGS. 1-12 illustrate an exemplary embodiment of the incubator of this invention, which is designated generally as reference numeral 100. As shown, incubator 100 is a table top style incubator that uses a two piece construction with a removable top assembly 110 seated atop a bottom assembly 120. Incubator 100 allows water to be added to the incubator to maintain desired humidity levels without removing the top assembly from the bottom assembly. Incubator 100 has a generally rectangular configuration and foot print and is designed to incubate forty-two poultry eggs, but may be shaped or scaled as needed.

Incubator 100 uses a conventional table top design and incorporates conventional incubator features, such as, electronic controls for heat, humidity and time, and an automated egg turner. As shown, Incubator 100 includes an electronic controller 20, an electric heater 30 and an automated egg turner 40. Controller 20, heater 30 and egg turner 40 are all of conventional design and operation. The design and operation of the controller, heater and egg turner are well known within the art, and therefore are not described in detail herein. Other embodiments, of the incubator of this invention may have any combination of features and can be adapted for use for both poultry and reptile egg incubation.

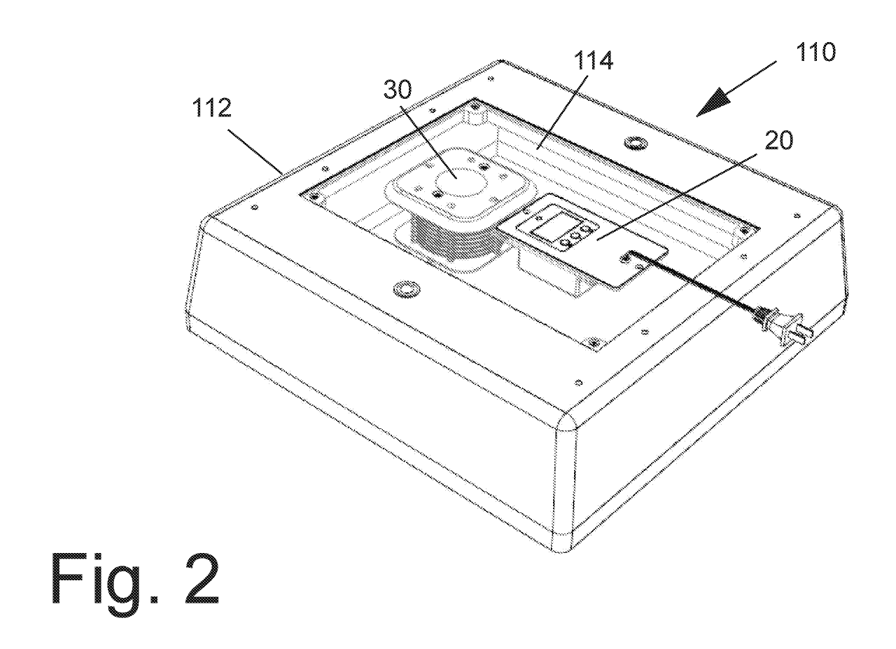

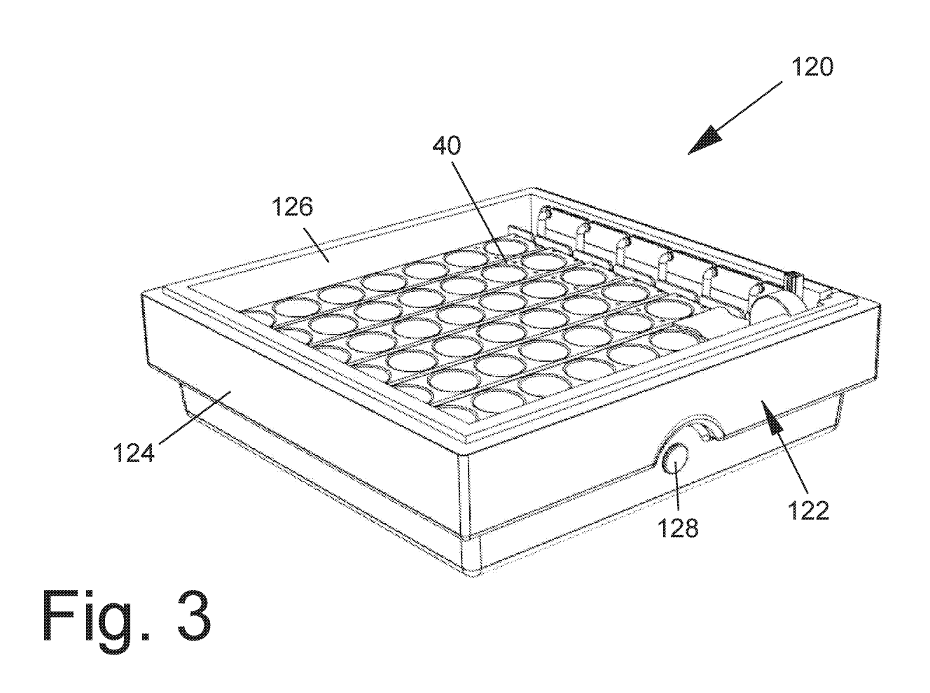

Top assembly 110 includes an insulated cover body 112 that supports and houses electronic controller 20 and electric heater 30 (FIG. 2). Cover body 112 is generally constructed or molded from a suitable thermal plastic material and has a top wall and sidewalls that define a cover interior. Top cover 112 also includes a transparent top panel 114 that allows users to view the eggs within the incubator interior. Bottom assembly 120 includes a base tray 122 that houses and supports automated egg turner 40 and a wire screen 50 (FIGS. 3-5). Base tray 122 is configured to have raised sidewalls extending from a bottom floor forming a tray interior. The top and bottom edges of the side wall edges of both the cover body and base tray are configured to mate so that top assembly 110 is securely supported atop bottom assembly 120.

Rather than a simple formed “Styrofoam” base, base tray 122 uses a pair of thermoplastic shells (inner shell 124 and outer shell 126) bonded together around an inner expanded polystyrene core (not shown). The thermoplastic shells 124 and 126 provide more durability and are easier to clean than conventional styrofoam trays. The polystyrene core provides thermal insulation to base tray 122. Base tray 122 is also configured to have a pair of recessed channels 123 and 125. Channels 123 and 125 serve as two separate water troughs that hold the water used to maintain the humidity within incubator 100. A fill port 127 extends through opposed sidewalls of base tray 122 into each channel 123 and 125. Removable plugs 128 enclose each of fill ports 127. Fill ports 127 allow water to be deposited directly into each channel 123 and 125 without removing top assembly 110 from bottom assembly 120. As shown, channels 123 and 125 extend across the entire area of the tray floor and are configured to have different lengths and hold different volumes of water.

The incubator of this invention provides several advantages over conventional table top style incubators. The inner and outer plastic shells enclosing the polystyrene core provide a more durable and sanitary base for the incubator. The plastic shells protect the easily damaged insulating core guard against damages and can be easily cleaned. Moreover, enclosing the insulating core within the plastic shells prevents bacteria and contaminants from migrating into the small porous gaps of the expanded polystyrene core. The channels formed in the floor of the base tray provide two integrated water reservoirs for the incubator. Internal incubator space is maximized by integrating water reservoirs into the base tray in the form of the floor channels. The channels extend across the entire area of the tray floor to evenly draw moisture into the incubator interior. The recessed channels also do not interfere with the egg trays of the automated egg turner. The fill ports formed in the sidewalls of the base tray allow water to be added into the floor channels without removing the top assembly and dramatically disrupting the control environment of the incubator.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. An egg incubator comprising:
a first assembly; and a second assembly detachably mounted atop of the first assembly, the first assembly includes a base tray having a tray floor and peripheral tray sidewall defining an tray interior therein, the tray floor having a recessed channel open to the tray interior for receiving water therein, the tray sidewall having a fill port extending there through and opening into the channel for adding water into the channel through the tray sidewall.

2. The incubator of claim 1 wherein the second assembly includes a removable plug enclosing the fill port.

3. The incubator of claim 1 wherein the base tray includes an inner shell and a outer shell bonded together to enclose an insulating core.

4. The incubator of claim 3 wherein the inner shall and outer shell are formed and constructed of a thermoplastic material, the insulating core is formed and constructed of an expanded polystyrene material.

5. The incubator of claim 1 wherein the second assembly includes a cover body mountable to the base tray to enclose the tray interior.

6. The incubator of claim 1 wherein the second assembly includes a heating element and an electronic controller operative connected to the heating element to control the temperature and humidity within the tray interior.

7. The incubator of claim 6 wherein the first assembly includes an automated egg turner supported by the base tray within the tray interior and operatively connected to the controller.

8. An egg incubator comprising:
a first assembly; and a second assembly detachably mounted atop of the first assembly,
the first assembly includes a base tray having a tray floor and peripheral tray sidewall defining an tray interior therein, the tray floor having a recessed channel open to the tray interior for receiving water therein, the tray sidewall having a fill port extending there through and opening into the channel for adding water into the channel through the tray sidewall, the base tray includes an inner shell and a outer shell bonded together to enclose an insulating core, the inner shall and outer shell are formed and constructed of a thermoplastic material, the insulating core is formed and constructed of an expanded polystyrene material,
the second assembly includes a cover body mountable to the base tray to enclose the tray interior, a heating element and an electronic controller operative connected to the heating element to control the temperature and humidity within the tray interior,
the first assembly also includes a removable plug enclosing the fill port and an automated egg turner supported by the base tray within the tray interior and operatively connected to the controller.
